(19) United States
(12) Patent Application Publication
(10) Pub. No.: US 2011/0128286 A1
(43) Pub. Date: Jun. 2, 2011

(54) IMAGE RESTORATION APPARATUS AND METHOD THEREOF

(75) Inventors: Ji Young PARK, Daejeon (KR); Bonki Koo, Daejeon (KR)

(73) Assignee: Electronics and Telecommunications Research Institute, Daejeon (KR)

(21) Appl. No.: 12/695,319

(22) Filed: Jan. 28, 2010

(30) Foreign Application Priority Data
Dec. 2, 2009 (KR) 10-2009-0118670

(51) Int. Cl. G06T 17/00

(52) U.S. Cl. 345/424

(57) ABSTRACT

An image restoration apparatus includes: a control processor unit for separating foreground and background from a loaded input image to transmit each of the separated foreground and background images as a three-dimensional (3D) texture; and a graphic processor unit for generating a visual hull of voxel units corresponding to the transmitted 3D texture, transforming the generated visual hull into mesh units, performing data alignment and pixel transform, determining a screen display value to perform rendering using the determined screen display value.

### CROSS-REFERENCE TO RELATED APPLICATIONS

The present invention claims priority of Korean Patent Application No. 10-2009-0118670, filed on Dec. 2, 2009, which is incorporated herein by reference.

### FIELD OF THE INVENTION

The present invention relates to an image restoration technique; and more particularly, to an image restoration apparatus and method, which are suitable for restoring a three-dimensional (3D) image using a multi-view input image.

### BACKGROUND OF THE INVENTION

As well-known in the art, most studies of restoring three-dimensional (3D) objects have been conducted to allow robot vision or machine vision systems to reconstruct or identify the structure of actual scenes or shape of objects.

Such 3D restoration techniques can be largely classified into two: a technique using additional hardwares, e.g., range scanner, structured light pattern, depth camera and the like; and a technique (e.g., stereo matching, motion-based shape estimation, focus variation-based technique, a technique using silhouettes and the like) using a general charge coupled device (CCD) camera without any special hardware.

The restoration of 3D structures using separate hardwares provides excellent accuracy, but it is difficult in real-time to reconstruct moving objects. Therefore, there have been mainly studied techniques of restoring 3D structures without any separate hardware.

Among these 3D structure restoring algorithms that can be applied to real-time systems, the recently used algorithm is a method using a silhouette image which can be easily acquired within the house where the camera is fixed and is also relatively easy to implement. Here, when image restoration is conducted from a silhouette image in 3D space, a visual hull refers to a set of volume pixels or voxels in the reconstructed 3D image.

In a technique of restoring such a visual hull, a 3D image can be reconstructed in a manner that a virtual 3D cube is created in a 3D space and a silhouette portion of each silhouette image is then backward projected to remain inner voxels therein and remove regions other than the silhouette.

Meanwhile, a method for restoring 3D spatial information by combining multi-view 2D input images has been widely used to reconstruct a 3D image on an image basis. This method separates an object to be reconstructed and background from an input image to create a 3D model of voxel structure, i.e., a visual hull from the separated images.

As mentioned above, the conventional method has the restoration result of quality that is proportional to the number of viewpoints of input image obtained by photographing an object to be reconstructed and to an increased resolution of image. However, this acts as a factor of abruptly increasing an operation time.

### SUMMARY OF THE INVENTION

In view of the above, the present invention provides an image restoration apparatus and method, which is capable of rapidly restoring a high-resolution 3D image by performing operation processing and rendering pipeline processing using a graphic processor unit.

In accordance with a first aspect of the present invention, there is provided an image restoration apparatus including: a control processor unit for separating foreground and background from a loaded input image to transmit each of the separated foreground and background images as a three-dimensional (3D) texture; and a graphic processor unit for generating a visual hull of voxel units corresponding to the transmitted 3D texture, transforming the generated visual hull into mesh units, performing data alignment and pixel transform, determining a screen display value to perform rendering using the determined screen display value.

In accordance with a second aspect of the present invention, there is provided an image restoration method including: separating foreground and background from a loaded input image to transmit each of the separated foreground and background images as a three-dimensional (3D) texture; generating a visual hull of voxel units corresponding to the transmitted 3D texture to transform the generated visual hull into mesh units; and performing data alignment and pixel transform on the visual hull transformed into mesh units, and then determining a screen display value to perform rendering using the determined screen display value.

In accordance with an embodiment of the present invention, it is possible to render and reconstruct a 3D image using a multi-view 2D image by the operation unit and rendering pipeline in the graphic processor that supports a powerful parallel processing function, thereby significantly reducing time taken in rendering and executing a high-speed 3D restoration.

Specifically, when an input image is loaded, if foreground and background are separated from the loaded input image and each of the separated foreground and background images is transformed into a 3D texture for transmission thereof, a visual hull of voxel units corresponding to the transmitted 3D texture is generated and transformed into mesh units, data alignment is executed by a vertex shader, pixel transform is performed by a rasterizer, and a screen display value is determined by a pixel shader and then rendering is performed using the determined screen display value. Accordingly, the problems of the conventional techniques can be solved.

### BRIEF DESCRIPTION OF THE DRAWINGS

The objects and features of the present invention will become apparent from the following description of embodiments, given in conjunction with the accompanying drawings, in which:

FIG. 1 illustrates a block diagram of an image restoration apparatus which is suitable for restoring a 3D image using operation processing and rendering pipeline of a graphic processor in accordance with an embodiment of the present invention;

FIG. 2 depicts a detailed block diagram of a control processor unit which is suitable for separating an input image into foreground and background to transform each of them into a 3D texture for transmission thereof in accordance with the embodiment of the present invention;

FIG. 3 provides a detailed block diagram of a graphic processor unit which is suitable for rendering a 3D image by graphic operations and rendering pipeline in accordance with the embodiment of the present invention;

FIG. 4 is a flow chart illustrating a procedure of restoring a 3D image using operation processing and rendering pipeline of the graphic processor in accordance with the embodiment of the present invention; and

FIGS. 5A to 5D are views showing how to reconstruct a 3D image in accordance with the embodiment of the present invention.

### DETAILED DESCRIPTION OF THE EMBODIMENTS

Hereinafter, embodiments of the present invention will be described in detail with reference to the accompanying drawings which form a part hereof.

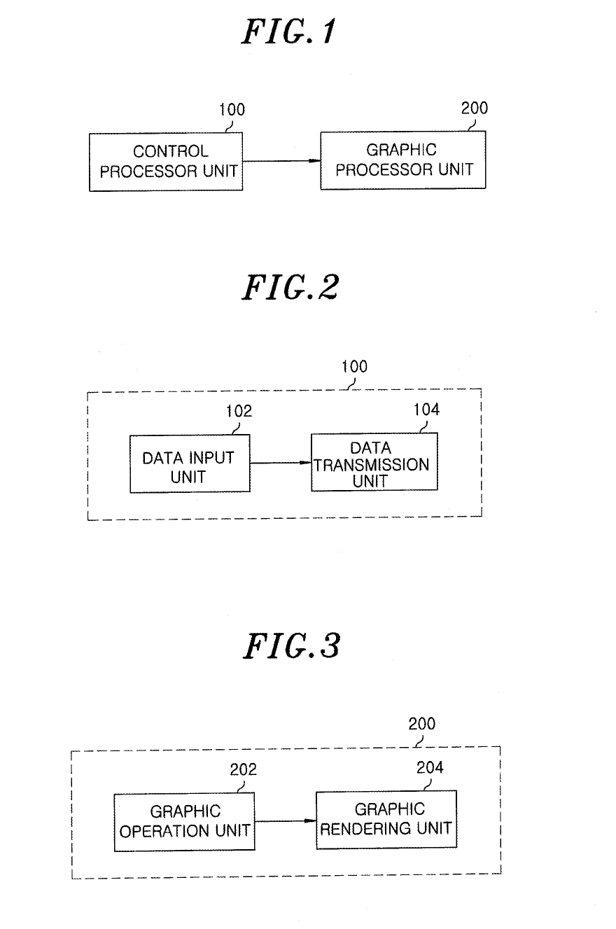

FIG. 1 illustrates a block diagram of an image restoration apparatus which is suitable for restoring a 3D image using operation processing and rendering pipeline of a graphic processor in accordance with the embodiment of the present invention. As illustrated in FIG. 1, the image restoration apparatus includes a control processor unit 100 and a graphic processor unit 200.

Referring to FIG. 1, when a multi-view image, i.e., a 2D image containing an object to be reconstructed is loaded, the control processor unit 100 separates foreground and background, i.e., the object and background from the loaded input image and transforms each of the separated foreground and background images into a 3D texture to transmit the same to the graphic processor unit 200.

The graphic processor unit 200 generates a visual hull of voxel units using multiple operation units to transform generated visual hull of voxel units into a visual hull of mesh units. That is, when a multi-view 2D image transformed into a 3D texture (i.e., a multi-view 2D image with separated foreground and background) is transmitted, the graphic processor unit 200 generates a visual hull of voxel units using this multi-view image through silhouette intersection.

In this visual hull generation, the amount of operation is proportional to the cube of a space size N, and to the number of viewpoints of input image. Further, the smaller size of voxels for spatial segment is, the more accuracy of voxel model increases. And the smaller the size of voxels is, the more resolution of voxels increases, which acts as a factor of increasing the amount of operation. Therefore, the computation of visual hull can be conducted through parallel processing using the graphic processor.

In addition, the graphic processor unit 200 transforms the generated visual hull from voxel units into mesh units, i.e., mesh structure which is the input form of the rendering pipeline. The reason is because, when the combination of input images and texture application to a 3D visual hull model are performed by the rendering pipeline to render the model later, parallel processing is available for respective pixels for screen output and thus significantly rapid texturing can be realized.

Further, the graphic processor unit 200 includes a rendering pipeline comprising, e.g., a vertex shader, a rasterizer, a pixel shader and the like, aligns data outputted from the vertex shader after the visual hull transformed into mesh units is inputted thereto to transform the aligned data into pixels by the rasterizer. Based on the pixels, a value to be displayed on the screen, i.e., a screen display value is determined by the pixel shader and rendering is performed using the screen display value to reconstruct a 3D image.

For instance, when mesh data (i.e., visual hull) of 3D model transformed into mesh units is inputted to the rendering pipeline, the rendering pipeline can transform the mesh data into 2D display data through geometric transform depending on a user point of view and determine a texture value, i.e., a screen display value of pixels to be finally rendered on the screen with reference to the input image including 3D textures.

Therefore, when the foreground and background are separated from the loaded input image and each of the separated foreground and background images is transformed into a 3D texture for transmission thereof, a visual hull of voxel units is generated through graphic operations and transformed into mesh units, and a screen display value is determined by the rendering pipeline and rendering is performed using the screen display value, thereby implementing a high-speed restoration of the 3D image through, parallel processing.

FIG. 2 shows a detailed block diagram of the control processor unit which is suitable for separating an input image into foreground and background to transform each of them into a 3D texture for transmission thereof in accordance with one embodiment of the present invention. As shown in FIG. 2, the control processor unit 100 includes a data input unit 102 and a data transmission unit 104.

Referring to FIG. 2, when a multi-view image, i.e., a 2D image including an object to be reconstructed is loaded, the data input unit 102 separates foreground and background (i.e., the object and background) from the loaded input image.

The data transmission unit 104 transforms each of the separated foreground and background images into a 3D texture and transmits the same to the graphic processor unit 200.

Here, the graphic processor unit 200 has, as internal memories thereof, a common memory allocated for general operations and a separate texture memory. The common memory is characterized in that it has a high frequency of use for operations, but has a relatively limited size and has a slower rate than a transfer rate of data.

Therefore, the input image is managed by the texture memory rather than by the common memory, thus ensuring the maximal space of the common memory to be used for operations. For the texture memory, since only texture data in the form defined by the graphic processor can be managed, a multi-view 2D input image is constructed in the form of a 3D texture map and then transmitted. Accordingly, image transmission can be done at a time, thereby ensuring the maximal space of the common memory for operations and also overcoming the problem of relatively slow transfer rate.

As a result, when a multi-view 2D image including an object to be reconstructed is loaded, foreground and background are separated from the loaded input image and each of the separated foreground and background images is transformed into a 3D texture for transmission thereof, thereby effectively transmitting the 2D image to reconstruct a 3D image.

FIG. 3 illustrates a detailed block diagram of the graphic processor unit which is suitable for rendering a 3D image through graphic operations and rendering pipeline in accordance with an embodiment of the present invention. As illustrated in FIG. 3, the graphic processor unit 200 includes a graphic operation unit 202 and a graphic rendering unit 204.

Referring to FIG. 3, the graphic operation unit 202 generates a visual hull of voxel units using multiple operation units to transform voxel units into mesh units. That is, when a multi-view 2D image transformed into a 3D texture (i.e., a multi-view 2D image with separated foreground and background) is transmitted, the graphic operation unit 202 generates a visual hull of voxel units using this multi-view image through silhouette intersection.

In this visual hull generation, the amount of operation is proportional to the cube of a space size N, and to the number of viewpoints of the input image. Further, the smaller size of voxels for spatial segmentation is, the more accuracy of voxel model increases. Furthermore, the smaller the size of voxels is, the more resolution of voxels increases, which acts as a factor of increasing the amount of operation. Therefore, the computation of visual hull can be conducted through parallel processing using the graphic processor.

At this time, voxels are divided and managed in tree structure to match the number of operation units supported by the graphic processor, each voxel being processed in a way that central point thereof is projected onto a 3D texture map for parallel processing. An error occurring in a technique that a point is projected to a region can be compensated for by making the size of voxels relatively small.

Further, the graphic operation unit 202 transforms the generated visual hull from voxel units into mesh units i.e., meth structures which is the input form of the rendering pipeline. The reason is because, when the combination of input images and texture application to the 3D visual hull model are performed by the rendering pipeline to render the model later, parallel processing is available for respective pixels for screen output and thus significantly rapid texturing can be realized.

This mesh transform can be performed in a manner that generates a mesh model having the outer part of the voxel model expressed in a mesh form by applying marching cubes when the visual hull model of voxel structure is input, and can also be conducted in parallel for respective meshes.

Next, the graphic rendering unit 204 servers to render a 3D image using the rendering pipeline. The rendering pipeline includes, e.g., a vertex shader, a rasterizer, a pixel shader, and the like, and aligns data which is outputted from the vertex shader after the visual hull transformed into mesh units is inputted thereto to transform the aligned data into pixels by the rasterizer. Based on the pixels, a value to be displayed on the screen i.e., a screen display value is determined by the pixel shader and rendering is performed using the screen display value to reconstruct a 3D image.

For instance, when mesh data, i.e., a visual hull of 3D model transformed into mesh units is input to the rendering pipeline, the rendering pipeline can transform the mesh data into 2D display data through geometric transform depending on a user point of view to determine a texture value, i.e., a screen display value of pixels to be finally rendered on the screen with reference to the input image including 3D textures. Here, if texturing is carried out by the pixel shader, only a texture value of pixels to be displayed on the screen is processed in parallel, so that the screen display value can be determined relatively rapidly. If the rendering pipeline refers to a depth value of 3D model, i.e., a distance value at z axis in the model therein, a more sophisticated texture can be determined compared with the case of performing only texturing.

As a result, a visual hull of voxel units corresponding to the transmitted 3D texture is generated and transformed into mesh units, data alignment is executed by the vertex shader, pixel transform is performed by the rasterizer, and a screen display value is determined by the pixel shader and rendering is performed using the determined screen display value, thereby effectively restoring the 3D image.

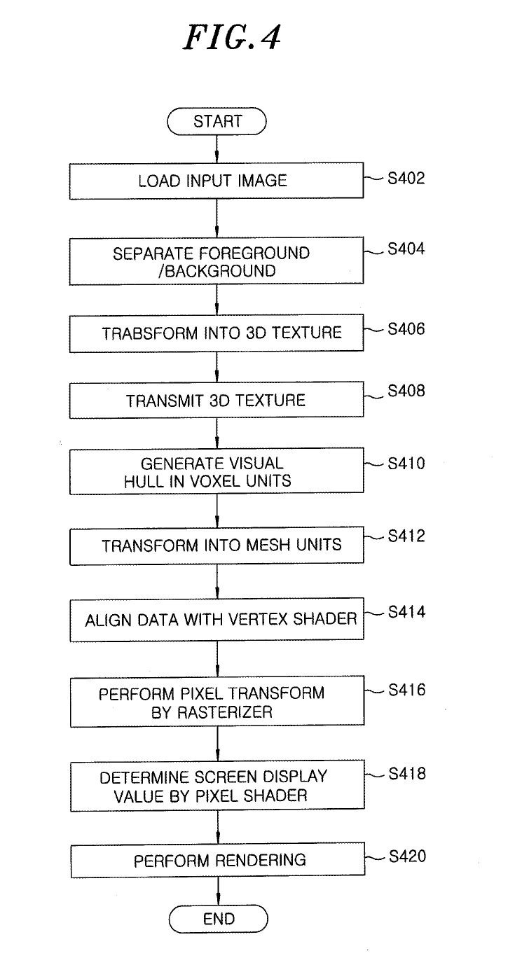

FIG. 4 is a flow chart illustrating a procedure of restoring a 3D image using operation processing and rendering pipeline of the graphic processor in accordance with an embodiment of the present invention.

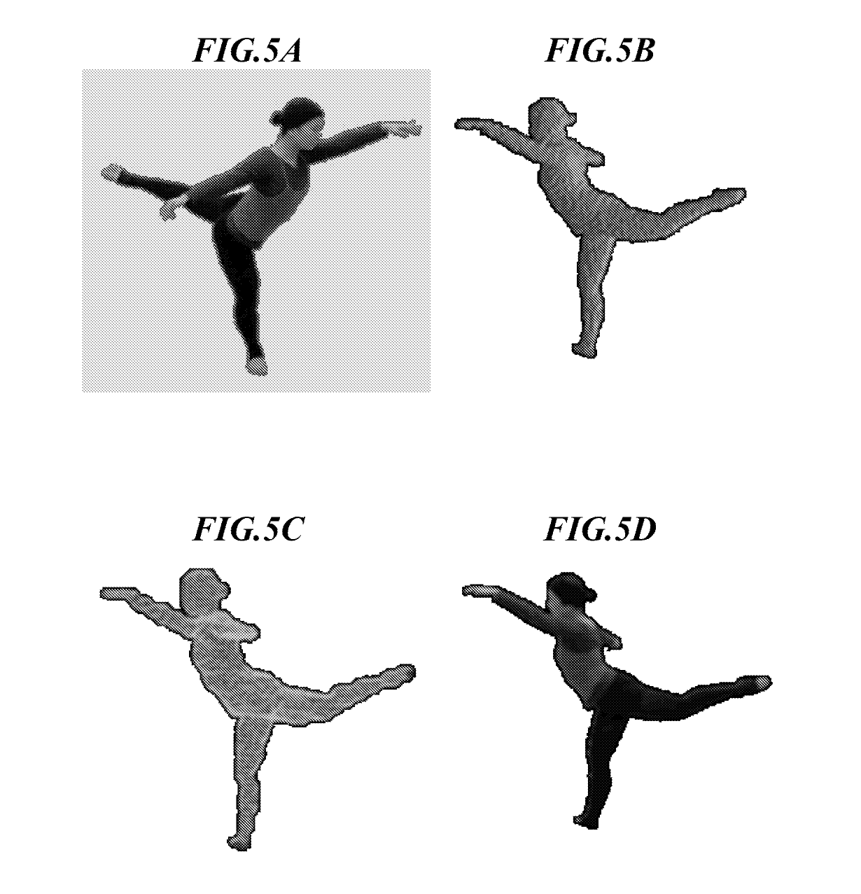

Referring to FIG. 4, when a multi-view image (i.e., a 2D image) including an object to be reconstructed is loaded in step S402, the data input unit 102 separates foreground and background (i.e., the object and background) from the loaded input image in step S404. For example, FIGS. 5A to 5D are views for explaining how to reconstruct a 3D image in accordance with the embodiment of the present invention, wherein FIG. 5A shows an image with separated foreground and background.

Next, the data transmission unit 104 transforms each of the separated foreground and background images into a 3D texture in step S406, and then transmits the image transformed into the 3D texture to the graphic processor unit 200 in step S408.

Here, the graphic processor unit 200 includes, as internal memories thereof, a common memory allocated for general operations and a separate texture memory. The common memory is characterized in that it has a high frequency of use for operations, but has a relatively limited size and has a slower rate than a transfer rate of data. Therefore, the input image is managed by the texture memory rather than by the common memory, thus securing the maximal space of the common memory to be used for operations. For the texture memory, since only texture data of form defined by the graphic processor can be managed, a multi-view 2D input image is constructed in the form of 3D texture map and then transmitted. Accordingly, image transmission can be conducted at a time, thereby ensuring the maximal space of the common memory for operations and also overcoming the problem of relatively slow transfer rate.

Next, in step S410, when the multi-view 2D image transformed into the 3D texture (i.e., the multi-view 2D image with separated foreground and background) is transmitted, the graphic operation unit 202 generates a visual hull of voxel units using this multi-view image through silhouette intersection. For example, an image shown in FIG. 5B represents a visual hull of voxel units.

In this visual hull generation, the amount of operation is proportional to the cube of a space size N, and to the number of viewpoints of the input image. Further, the smaller size of voxels for spatial segment is, the more accuracy of voxel model increases. And the smaller the size of voxels is, the more the resolution of voxels increases, which acts as a factor of increasing the amount of operation. Thus, the computation of visual hull can be conducted through parallel processing using the graphic processor.

At this time, voxels are divided and managed in tree structure to match the number of operation units supported by the graphic processor, each voxel being processed in a way that central point thereof is projected to a 3D texture map for parallel processing. An error occurring in a technique that a point is projected to a region can be compensated for by making the size of voxels relatively small.

Further, the graphic operation unit 202 transforms the generated visual hull from voxel units into mesh units in step S412. The reason of transform into mesh units i.e., mesh structure is because, when the combination of input images and texture application to a 3D visual hull model are performed by the rendering pipeline to render the model later, parallel processing is available for respective pixels for screen output and thus significantly rapid texturing can be achieved.

This mesh transform can be performed in a manner that generates a mesh model having the outer part of the voxel model expressed in a mesh form by applying marching cubes when the visual hull model of voxel structure is inputted, and also be processed in parallel for respective meshes. For example, an image shown in FIG. 5C represents a visual hull transformed into mesh units using the marching cubes.

Next, in steps S414 and S416, the graphic rendering unit 204 aligns data which is outputted from the vertex shader after the visual hull transformed into mesh units is inputted thereto to transform the aligned data into pixels by the rasterizer.

Based on the pixels, in step S418, the graphic rendering unit 204 determines a value to be displayed on the screen, i.e., a screen display value by the pixel shader.

Next, in step S420, the graphic rendering unit 204 performs rendering using the determined screen display value to reconstruct the 3D image. For example, an image depicted in FIG. 5D represents a reconstructed 3D image.

For instance, when mesh data, i.e., a visual hull of 3D model transformed into mesh units, is input to the rendering pipeline, the rendering pipeline can transform the mesh data into 2D display data through geometric transform depending on a user point of view and determine a texture value, i.e., a screen display value of pixels to be finally rendered on the screen with reference to the input image consisting of 3D textures. Here, if texturing is performed by the pixel shader, only a texture value of pixels to be displayed on the screen is processed in parallel, so that the screen display value can be determined relatively rapidly. If the rendering pipeline refers to a depth value of 3D model, i.e., a distance value at z axis in the model therein, a more sophisticated texture can be determined compared with the case of performing only texturing.

Accordingly, when the foreground and background are separated from the loaded input image and each of the separated foreground and background images is transformed into a 3D texture for transmission thereof, a visual hull of voxel units is generated by graphic operations and transformed into mesh units, and a screen display value is determined by the rendering pipeline and rendering is performed using the screen display value, thereby implementing a high-speed restoration of a 3D image through parallel processing.

While the invention has been shown and described with respect to the embodiments, it will be understood by those skilled in the art that various changes and modifications may be made without departing from the scope of the invention as defined in the following claims.

What is claimed is:

1. An image restoration apparatus comprising:
a control processor unit for separating foreground and background from a loaded input image to transmit each of the separated foreground and background images as a three-dimensional (3D) texture; and
a graphic processor unit for generating a visual hull of voxel units corresponding to the transmitted 3D texture, transforming the generated visual hull into mesh units, performing data alignment and pixel transform, determining a screen display value to perform rendering using the determined screen display value.

2. The apparatus of claim 1, wherein the control processor unit includes:
a data input unit for separating the foreground and background from the loaded input image that is a multi-view image; and
a data transmission unit for transforming each of the separated foreground and background images into the 3D texture to transmit the transformed 3D texture.

3. The apparatus of claim 1, wherein the graphic processor unit includes:
a graphic operation unit for generating the visual hull of voxel units corresponding to the 3D texture by an operation unit to transform the generated visual hull into mesh units; and
a graphic rendering unit for aligning data of the visual hull by a rendering pipeline, performing the pixel transform, determining the screen display value to perform rendering using the determined screen display value.

4. The apparatus of claim 3, wherein the graphic operation unit divides and manages voxels in tree structure based on the number of operation units.

5. The apparatus of claim 4, wherein the graphic operation unit is executed such that projects a central point of each of the voxels to a 3D texture map to execute parallel processing on the respective voxels of the visual hull in tree structure based on the number of the operation units.

6. The apparatus of claim 5, wherein the graphic operation unit is executed such that a mesh model having the outer part of a voxel model expressed in a mesh form is generated by applying marching cubes.

7. The apparatus of claim 3, wherein the graphic rendering unit aligns data which is outputted from a vertex shader after the visual hull transformed into mesh units is inputted to the vertex shader to transform the data into pixels by a rasterizer.

8. The apparatus of claim 7, wherein the graphic rendering unit determines the screen display value by a pixel shader based on the transformed pixels.

9. The apparatus of claim 8, wherein the graphic rendering unit performs parallel processing only on a texture value of pixels to be displayed on the screen when texturing is executed by the pixel shader.

10. The apparatus of claim 8, wherein the graphic rendering unit performs parallel processing only on a texture value of pixels to be displayed on the screen when texturing is executed by the pixel shader, while a reference to a depth value of a 3D model is made by the rendering pipeline.

11. An image restoration method comprising:
separating foreground and background from a loaded input image to transmit each of the separated foreground and background images as a three-dimensional (3D) texture;
generating a visual hull of voxel units corresponding to the transmitted 3D texture to transform the generated visual hull into mesh units; and
performing data alignment and pixel transform on the visual hull transformed into mesh units, and then determining a screen display value to perform rendering using the determined screen display value.

12. The method of claim 11, wherein said transmitting each of the separated foreground and background images includes:
separating the foreground and background from the loaded input image that is a multi-view image; and
transforming each of the separated foreground and background images into the 3D texture to transmit the transformed 3D texture.

13. The method of claim 11, wherein said transforming the generated visual hull into mesh units includes generating the visual hull of voxel units corresponding to the 3D texture by an operation unit to transform the generated visual hull into mesh units.

14. The method of claim 13, wherein said determining a screen display value to perform rendering includes aligning data of the visual hull by a rendering pipeline, performing the pixel transform, determining the screen display value to perform rendering using the determined screen display value.

15. The method of claim 14, wherein said transforming the generated visual hull into mesh units includes projecting a central point of each of the voxels to a 3D texture map to execute parallel processing on the respective voxels of the visual hull.

16. The method of claim 15, wherein said transforming the generated visual hull includes generating a mesh model having the outer part of a voxel model expressed in a mesh form by applying marching cubes.

17. The method of claim 14, wherein said determining a screen display value to perform rendering includes aligning data which is outputted from a vertex shader after the visual hull transformed into mesh units is inputted to the vertex shader, transforming the data into pixels by a rasterizer to determine the screen display value by a pixel shader based on the transformed pixels.

18. The method of claim 17, wherein said determining a screen display value to perform rendering includes performing parallel processing only on a texture value of pixels to be displayed on the screen when texturing is executed by the pixel shader.

19. The method of claim 17, wherein said determining a screen display value to perform rendering includes performing parallel processing only on a texture value of pixels to be displayed on the screen when texturing is executed by the pixel shader, while a reference to a depth value of a 3D model is made by the rendering pipeline.
